(19) United States
(12) Patent Application Publication
(10) Pub. No.: US 2008/0245364 A1
(43) Pub. Date: Oct. 9, 2008

(54) Filtering respirator with nasal and oral separation

(76) Inventor: Keith Patterson, Alexandria, VA (US)

Correspondence Address: OLIFF & BERRIDGE, PLC, P.O. BOX 320850, ALEXANDRIA, VA, 22320-4850, US

(21) Appl. No.: 11/730,713

(22) Filed: Apr. 3, 2007

(51) Int. Cl. A62B 7/10; A62B 18/02; A62B 18/10

(52) U.S. Cl. 128/201.25; 128/201.18; 128/201.28

(57) ABSTRACT

A respirator includes a first chamber, a second chamber, and a separator that separates the first chamber and the second chamber. A filtration system includes an inhale valve that only allows air to enter the respirator and an exhale valve that only allows air to exit the respirator. The system can be reversed so that the inhale valve and exhale valve may be positioned on either the first or second chamber. A replaceable filter can be provided that includes a supply canister including a supply of filter material, a take-up canister that receives used filter material, and a path between the supply canister and the take-up canister that guides the filter material across the respirator's inhale valve, exhale valve, or both the inhale and exhale valves.

### BACKGROUND

The present invention relates generally to a filtering respirator.

Related art respirators have a variety of uses, including protecting a user from harmful bacteria or particles contained within unfiltered air. However, existing respirators do not adequately account for various situations, such as when a user wants to replace the respirator's filter or change the flow of air into and out of the respirator, without becoming exposed to unfiltered air, and/or wants to separate air flow between the nose and mouth.

### SUMMARY

Exemplary embodiments of a respirator comprise a first chamber, a second chamber and a filtration system. The filtration system includes an inhale valve and an exhale valve, so that air may be inhaled into the first chamber, and exhaled through the second chamber.

Additionally, in some embodiments, the filtration system can be reversed so that inhale valve allows air to be inhaled into the second chamber and so that exhale valve allows air to be exhaled from the first chamber. This can prove especially useful, for example, if a user needs to sneeze. If the user has the inhale valve positioned with respect to the second chamber, the user can quickly change to the exhale valve if the user needs to sneeze. This will allow the user to sneeze without needing to remove the respirator, thereby avoiding becoming exposed to unfiltered air.

Some embodiments may include a replaceable filter. The replaceable filter includes a supply canister including a supply of filter material, a take-up canister that receives used filter material, and a crank, annular engaging mechanism, or the like. The filter material is passed over the inhale and/or exhale valves and the user may engage the crank, annular engaging mechanism, or the like to roll used material into the take-up canister so as to place a fresh portion of the filter material over the inhale and/or exhale valves.

Embodiments of the respirator can have a variety of uses. For example, medication or anesthesia could be applied to a filter within the filtration system. Additionally, the respirator could be used to regulate breathing to help with sleep apnea.

These and other objects, advantages and salient features of the invention are described in or apparent from the following description of embodiments.

### BRIEF DESCRIPTION OF THE DRAWINGS

Exemplary embodiments will be described with reference to the accompanying drawings, in which like numerals represent like parts, and wherein:

FIG. 1 is a side view of an embodiment of a filtering respirator with nasal and oral separation;

FIGS. 2-4 illustrate a filtering respirator with an exemplary embodiment of a reversing member during rotation;

FIG. 5 is a front view of an embodiment of a respirator with a replaceable filter;

FIG. 6 is an exploded view of the replaceable filter shown in FIG. 3; and

FIG. 7 is a front view of an embodiment of a respirator with two replaceable filters.

### DETAILED DESCRIPTION OF EMBODIMENTS

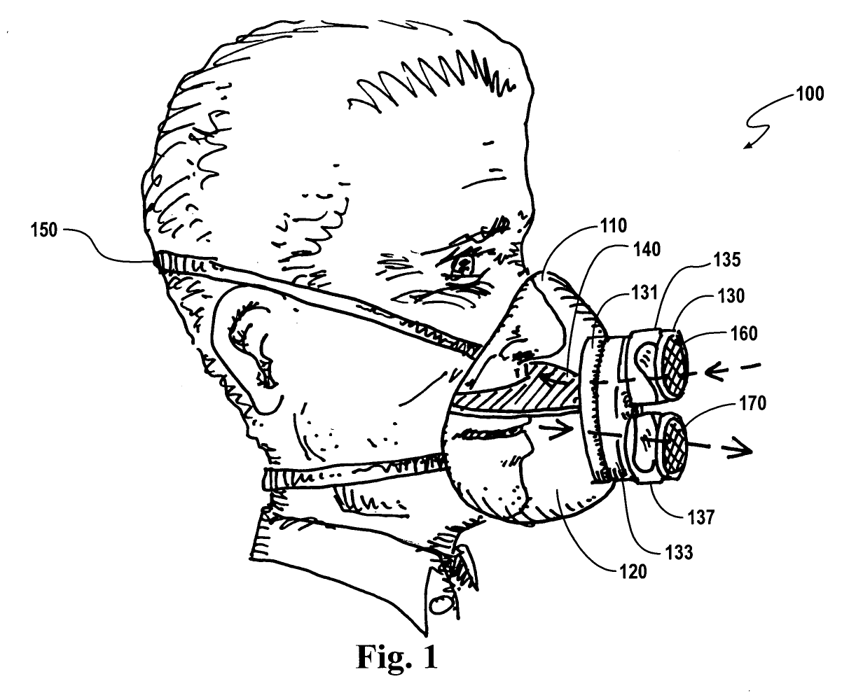

An exemplary embodiment of a respirator is shown in FIG. 1. The respirator 100 can be worn over the nose and mouth of a user and can be secured to the user by a fastener 150. While the fastener 150 in this exemplary embodiment uses two elastic straps, various fasteners can be used. For example, the respirator 100 can be secured to the user by a single tied string, or by a Velcro strap. As another example, the respirator 100 can be attached to or incorporated into a protection helmet, hood, face shield, goggles or the like.

The respirator 100 comprises a first chamber 110, a second chamber 120 and a filtration system 130. The first chamber 110 and the second chamber 120 are isolated from each other by a separator 140 so that the air in the first chamber 110 is not intermixed with the air in the second chamber 120.

The filtering system 130 includes a base member 131, a reversing member 133, an inhale valve 135 and an exhale valve 137. The inhale valve 135 and exhale valve 137 are one-way valves that may be covered with filters 160, 170. The filters 160, 170 may be replaceable. The inhale valve 135 allows air to enter the first chamber 110 or the second chamber 120 without air being able to exit through the inhale valve 135. Conversely, the exhale valve allows air to exit the first chamber 110 or the second chamber 120 without allowing air to enter through the exhale valve 135. The base member 131 has an opening (not shown) that allows air to pass between the inhale valve 135 or the exhale valve 137 and the first chamber 110, and an opening (not shown) that allows air to pass between the inhale valve 135 or the exhale valve 137 and the second chamber 120.

The replaceable filters 160,170 may be made of any suitable filtering material and may be located on the first chamber 110, the second chamber 120, or both. The filtering material may be scented or flavored, so that the user can have a pleasant experience while wearing the respirator. Additionally, or alternatively, medication can be provided on the filter so that the mask can be used to deliver medicine during a medical procedure or treatment, or to kill harmful bacteria.

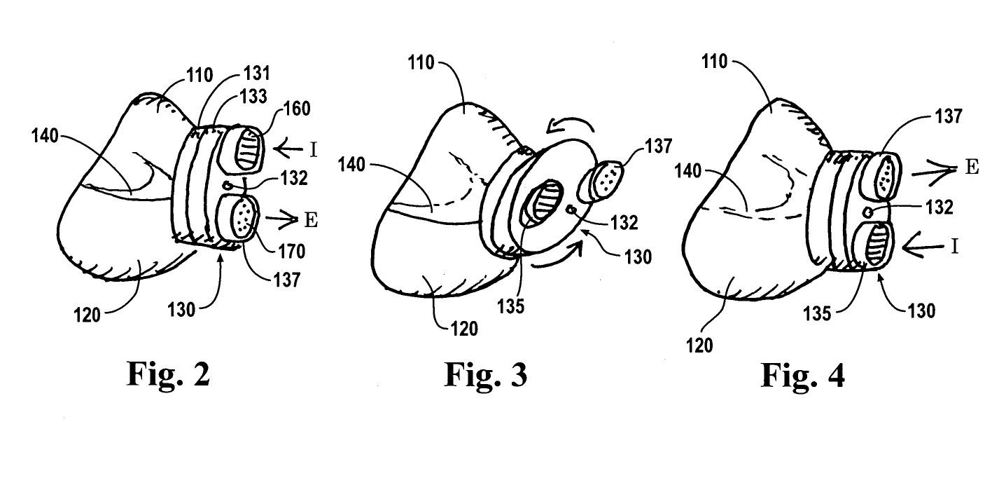

FIGS. 2-4 show an exemplary embodiment of a reversing operator of the respirator 100. The reversing member 133 can be rotated with respect to the base member 131, via a pin 132, an annular engaging mechanism (not shown), or the like. The annular engaging mechanism would include parts formed respectively on the base member 131, the reversing member 133, or the like. Rotating the reversing member 133 places the inhale valve 135 and the exhale valve 137 in communication with either the first chamber 110 or the second chamber 120.

FIG. 2 shows the filtering system 130 at a first position. The inhale valve 135 is positioned to be in communication with the first chamber 110, and only allows air to enter the first chamber 110, as shown by arrow I. The exhale valve 137 is positioned to be in communication with the second chamber 120, and only allows air to exit the second chamber 120, as shown by arrow E.

FIG. 3 shows the filtering system 130 during rotation. The base member 131 remains stationary, and the reversing member 133 rotates in either a clockwise or counterclockwise direction to reposition the inhale valve 135 and exhale valve 137.

FIG. 4 shows the filtering system 130 at a second position. The inhale valve 135 is positioned to only allow air to enter the second chamber 120, as shown by arrow I. The exhale valve 137 is positioned to only allow air to exit the first chamber 110, as shown by arrow E.

When a user wears the respirator 100, the user can be protected from harmful bacteria or particles in the unfiltered air outside the respirator. For example, a filter could be provided only on the inhale valve 135. Additionally, or alternatively, any bacteria or germs that are carried by the user can be contained by the respirator 100 by providing a filter over exhale valve 137, and therefore protect individuals around the user.

The uses of the respirator 100 are not limited to protection from bacteria or particles. For example, an athlete can train his or her breathing using respirator 100. For example, if the athlete wishes to train to breathe in through his or her nose and out through his or her mouth, he or she could adjust the reversing member 133 to be in a position where the inhale valve 135 is in communication with the first chamber 110 and the exhale valve 137 is in communication with the second chamber 120. Alternatively, if the athlete wishes to train to breathe in through his or her mouth and out through his or her nose, he or she could adjust the reversing member 133 to be in a position where the inhale valve 135 is in communication with the second chamber 120 and the exhale valve 137 is in communication with the first chamber 110.

Another example of a use for the respirator 100 is in aiding individuals who suffer from sleep apnea. The user can adjust the reversing member 133 to regulate his or her breathing by moving the reversing member 133 so that the inhale valve 135 and the exhale valve 137 are located at a desired position. Additionally, tubing and/or an air pressurizing device could be attached to the respirator 100 to help regulate the flow of air to the user.

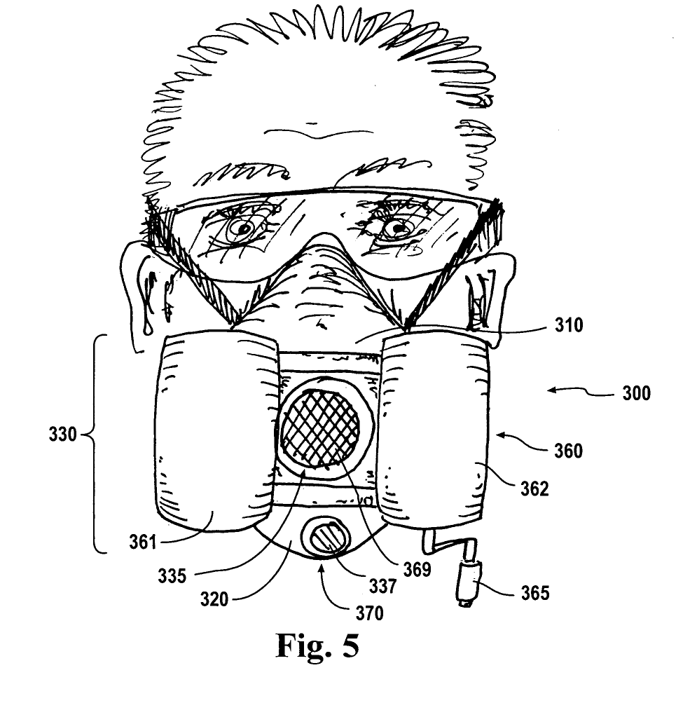

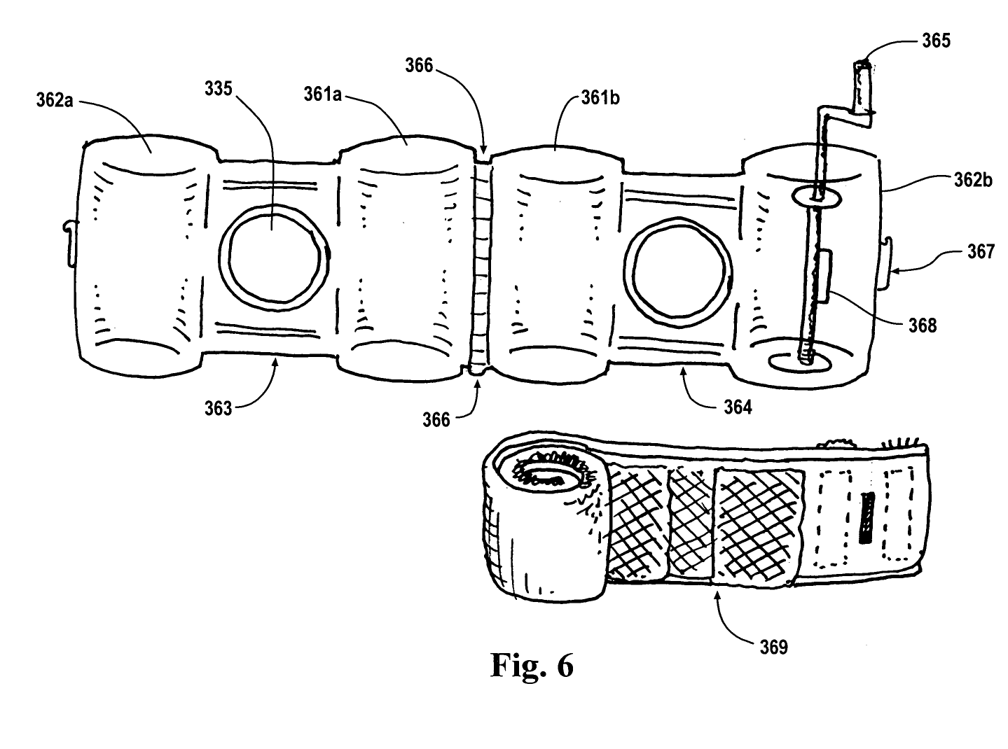

FIGS. 5-6 show a second exemplary embodiment of a respirator 300. The second exemplary embodiment comprises a first chamber 310, a second chamber 320, and a filtration system 330 with replaceable filters 360, 370. The second exemplary embodiment differs from the first exemplary embodiment with respect to replaceable filter 360.

Replaceable filter 360 comprises a first canister 361, a second canister 362, and a crank 365. Filter material 369 is rolled and placed in first canister 361, passed over inhale valve 335, and wound around crank 365 by engagement with an engager 368. When the filter material 369 needs to be changed, a user may turn the crank 365 to roll used material into the second canister 362 and around crank 365. This allows the user to place a fresh portion of filter material 369 over inhale valve 335. Instead of or in addition to the crank 365, a motor may be provided to place a fresh portion of filter material 369 over inhale valve 335 either based on elapsed time or some other indicator, such as manual indication by the user, that the filter material 369 needs to be changed. While FIG. 5 shows replaceable filter 360 being located on inhale valve 335, replaceable filter 360 may be instead located on exhale valve 337.

FIG. 6 shows an interior view of replaceable filter 360 and a roll of filter material 369. The replaceable filter 360 is divided into first filter casing 363 and a second filter casing 364. The first filter casing 363 contains a first portion 361a of first canister 361 and a first portion 362a of second canister 362. The second filter casing 364 contains a second portion 361b of first canister 361 and a second portion 362b of second canister 362. The first filter casing 363 is attached to second filter casing 364 by a hinge 366. The hinge 366 allows the first filter casing 363 to pivot with respect to the second filter casing 364. The replaceable filter 360 may be placed in a closed position by swinging first filter casing 363 so that the first portions 361a, 362a of the first and second canisters 361, 362 come into contact with the second portions 361b, 362b of the first and second canisters 361, 362. The first and second filter casings 363, 364 may then be secured by securing member 367.

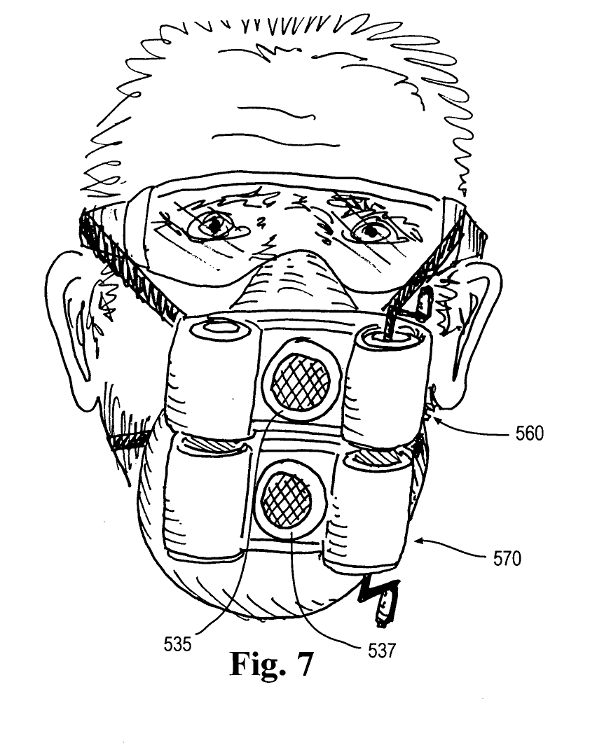

FIG. 7 shows a third exemplary embodiment. The third exemplary embodiment differs from the second exemplary embodiment in that replaceable filters 560, 570 are provided on both the inhale valve 535 and the exhale valve 537.

While the invention has been described in conjunction with a specific embodiments, these embodiments should be viewed as illustrative and not limiting. Various changes, substitutes, improvements or the like are possible within the spirit and scope of the invention.

For example, the shape and location of the inhale and exhale valves can be changed. Specifically, the inhale and exhale valves could be square, oval, or any other shape. As another example, the inhale and exhale valves could be located diagonally with respect to each other.

What is claimed is:

1. A respirator, comprising:
a first chamber;
a second chamber;
a separator that separates the first chamber from the second chamber and seals against a wearer's face such that the first chamber is in communication with the wearer's nasal passage and the second chamber is in communication with the wearer's mouth;
an inhale valve that only allows air to enter the respirator; and
an exhale valve that only allows air to exit the respirator.

2. The respirator according to claim 1, further comprising
a base member; and
a reversing member, the inhale valve and the exhale valve being provided on the reversing member, and the reversing member being rotatable with respect to the base member.

3. The respirator according to claim 1, further comprising filter material placed over at least one of the inhale valve or the exhale valve.

4. The respirator according to claim 3, wherein the filter material contains medication.

5. The respirator according to claim 3, wherein the filter material is scented.

6. A method for dispensing scent, comprising:
wearing the respirator according to claim 5.

7. A method for dispensing medication, comprising:
wearing the respirator according to claim 4.

8. A filter for use in a respirator, comprising:
a supply canister including a supply of filter material;
a take-up canister that receives used filter material;
a path between the supply canister and the take-up canister, the path guiding the filter material across a valve portion of the respirator, the valve portion including an inhale valve or an exhale valve.
